(19) United States
(12) Patent Application Publication
(10) Pub. No.: US 2007/0043137 A1
(43) Pub. Date: Feb. 22, 2007

(54) HIGHLY CROSS-LINKED AND WEAR-RESISTANT POLYETHYLENE PREPARED BELOW THE MELT

(75) Inventors: Orhun K. Muratoglu, Cambridge, MA (US); Stephen H. Spiegelberg, Winchester, MA (US)

Correspondence Address: PROSKAUER ROSE LLP, 1001 PENNSYLVANIA AVE, N.W.,, SUITE 400 SOUTH, WASHINGTON, DC, 20004, US

(73) Assignee: The General Hospital Corporation dba Massachusetts General Hospital, Boston, MA (US)

(21) Appl. No.: 11/465,551

(22) Filed: Aug. 18, 2006

Related U.S. Application Data
(60) Provisional application No. 60/709,799, filed on Aug. 22, 2005.

(51) Int. Cl. C08J 3/28

(52) U.S. Cl. 522/150

(57) ABSTRACT

The present invention provides irradiated crosslinked polyethylene containing reduced free radicals, preferably containing substantially no residual free radical. Processes of making crosslinked wear-resistant polyethylene having reduced free radical content, preferably containing substantially no residual free radicals, by mechanically deforming the irradiated PE either with or without contact with sensitizing environment during irradiation and annealing the post-irradiated PE at a temperature that is above the melting point of the PE, are also disclosed herein.

This application claims priority to U.S. provisional application Ser. No. 60/709,799, filed Aug. 22, 2005, the entirety of which is hereby incorporated by reference.

### FIELD OF THE INVENTION

The present invention relates to irradiated crosslinked polyethylene (PE) compositions having reduced free radical content, preferably containing reduced or substantially no residual free radicals, and processes of making crosslinked polyethylene. The invention also relates to processes of making crosslinked wear-resistant polyethylene having reduced free radical content, preferably containing substantially no residual free radicals, by mechanically deforming the irradiated PE either with or without contact with sensitizing environment during irradiation and annealing the post-irradiated PE at a temperature that is above the melting point of the PE.

### DESCRIPTION OF THE FIELD

Increased crosslink density in polyethylene is desired in bearing surface applications for joint arthroplasty because it significantly increases the wear resistance of this material. The preferred method of crosslinking is by exposing the polyethylene to ionizing radiation. Radiation crosslinking increases the wear resistance of UHMWPE (see Muratoglu et al., J Arth, 2001. 16(2):p 149-160; Karlholm et al., Hip Society, 2003). However, ionizing radiation, in addition to crosslinking, also will generate residual free radicals, which are the precursors of oxidation-induced embrittlement. This is known to adversely affect in vivo device performance. Post-irradiation melting decreases the mechanical properties of UHMWPE. Alternate crosslinking and stabilization methods are under development. It is desirable to reduce the residual free radical concentration in order to avoid significantly reducing the crystallinity of polyethylene, so as to permit insubstantial lowering, substantial maintenance, or an increase in the modulus. However, improvement in mechanical properties of highly crosslinked UHMWPE over first generation crosslinked UHMWPE was not possible with prior art practices.

### SUMMARY OF THE INVENTION

The invention relates to improved irradiated crosslinked polyethylene having reduced concentration of free radicals, made by the process comprising irradiating the polyethylene at a temperature that is below the melting point of the polyethylene, optionally while it is in contact with a sensitizing environment, in order to reduce the content of free radicals, preferably to an undetectable level, optionally through mechanical deformation.

In one aspect, the invention provides methods of making an irradiated crosslinked polyethylene composition comprising the steps of: a) mechanically deforming the polyethylene at a solid or a molten-state; b) crystallizing the polyethylene at the deformed state at a temperature below the melting point of polyethylene; c) irradiating the polyethylene that is below the melting point of the polyethylene; and d) heating the irradiated polyethylene to a temperature that is above the melting point for reduction of the concentration of residual free radicals and for shape recovery.

In another aspect, the invention provides irradiated crosslinked polyethylene composition made by the process comprising steps of: a) mechanically deforming the polyethylene at a solid- or a molten-state; b) crystallizing the polyethylene at the deformed state at a temperature below the melting point of polyethylene; c) irradiating the polyethylene that is below the melting point of the polyethylene; and d) heating the irradiated polyethylene to a temperature that is above the melting point for reduction of the concentration of residual free radicals and for shape recovery.

In accordance with one aspect of the present invention, there is provided an irradiated crosslinked polyethylene wherein crystallinity of the polyethylene is at least about 51% or more.

In accordance with another aspect of the present invention, there is provided an irradiated crosslinked polyethylene, wherein the elastic modulus of the polyethylene is higher or just slightly lower than, i.e. about equal to, that of the starting unirradiated polyethylene or irradiated polyethylene that has been subjected to melting.

According to the present invention, the polyethylene is a polyolefin and preferably is selected from a group consisting of a low-density polyethylene, high-density polyethylene, linear low-density polyethylene, ultra-high molecular weight polyethylene (UHMWPE), or mixtures thereof.

In one aspect of the present invention, the polyethylene is contacted with a sensitizing environment prior to irradiation. The sensitizing environment, for example, can be selected from the group consisting of acetylene, chloro-trifluoro ethylene (CTFE), trichlorofluoroethylene, ethylene or the like, or a mixture thereof containing noble gases, preferably selected from a group consisting of nitrogen, argon, helium, neon, and any inert gas known in the art. The gas can be a mixture of acetylene and nitrogen wherein the mixture comprising about 5% by volume acetylene and about 95% by volume nitrogen, for example.

In one aspect of the invention, the starting material of the polyethylene can be in the form of a consolidated stock or the starting material can be also in the form of a finished product.

In another aspect of the invention, the starting material of the polyethylene (for example, UHMWPE) can also contain an antioxidant and/or its derivatives, such as α-tocopherol or tocopherol acetate.

In another aspect of the invention, there is provided an irradiated crosslinked polyethylene with reduced free radical concentration, preferably with no detectable residual free radicals (that is, the content of free radicals is below the current detection limit of 10¹⁴ spins/gram), as characterized by an elastic modulus of about equal to or slightly higher than that of the starting unirradiated polyethylene or irradiated polyethylene that has been subject to melting. Yet in another aspect of the invention, there is provided a crosslinked polyethylene with reduced residual free radical content that is characterized by an improved creep resistance when compared to that of the starting unirradiated polyethylene or irradiated polyethylene that has been subjected to melting.

In accordance with one aspect of the invention there is provided a method of making a crosslinked polyethylene comprising irradiating the polyethylene at a temperature that is below the melting point of the polyethylene while it is in contact with a sensitizing environment in order to reduce the content of free radicals, preferably to an undetectable level.

In accordance with another aspect of the invention, there are provided methods of treating crosslinked polyethylene, wherein crystalline of the polyethylene is about equal to that of the starting unirradiated polyethylene, wherein crystallinity of the polyethylene is at least about 51% or more, wherein elastic modulus of the polyethylene is about equal to or higher than that of the starting unirradiated polyethylene or irradiated polyethylene that has been subjected to melting.

Also provided herein, the material resulting from the present invention is a polyethylene subjected to ionizing radiation with reduced free radical concentration, preferably containing substantially no residual free radicals, achieved through post-irradiation annealing in the presence of a sensitizing environment.

In one aspect of the invention, there is provided a method of making a crosslinked polyethylene, wherein the polyethylene is contacted with a sensitizing environment prior to irradiation.

In another aspect according to the present invention, there is provided a method of making a crosslinked polyethylene, wherein the sensitizing, environment is acetylene, chloro-trifluoro ethylene (CTFE), trichlorofluoroethylene, ethylene gas, or mixtures of gases thereof, wherein the gas is a mixture of acetylene and nitrogen, wherein the mixture comprises about 5% by volume acetylene and about 95% by volume nitrogen.

Yet in another aspect according to the present invention, there is provided a method of making a crosslinked polyethylene, wherein the sensitizing environment is dienes with different number of carbons, or mixtures of liquids and/or gases thereof.

One aspect of the present invention is to provide a method of making a crosslinked polyethylene, wherein the irradiation is carried out using gamma radiation or electron beam radiation, wherein the irradiation is carried out at an elevated temperature that is below the melting temperature, wherein radiation dose level is between about 1 and about 10,000 kGy.

In one aspect there is provided a method of making a crosslinked polyethylene, wherein the annealing in the presence of sensitizing environment is carried out at above an ambient atmospheric pressure of at least about 1.0 atmosphere (atm) to increase the diffusion rate of the sensitizing molecules into polyethylene.

In another aspect there is provided a method, wherein the annealing in the presence of sensitizing environment is carried with high frequency sonication to increase the diffusion rate of the sensitizing molecules into polyethylene.

Yet in another aspect there is provided a method of treating irradiated crosslinked polyethylene comprising steps of contacting the polyethylene with a sensitizing environment; annealing at a temperature that is above the melting point, about at least 135° C. of the polyethylene; and in presence of a sensitizing environment in order to reduce the concentration of residual free radicals, preferably to an undetectable level.

Another aspect of the invention provides an improved irradiated crosslinked polyethylene composition having reduced free radical concentration, made by the process comprising having at a temperature that is below the melting point of the polyethylene, optionally in a sensitizing environment; mechanically deforming the polyethylene in order to reduce he concentration of residual free radical and optionally annealing below the melting point of the polyethylene, preferably at about 135° C., in order to reduce the thermal stresses.

In accordance with one aspect of the invention, mechanical deformation of the polyethylene is performed in presence of a sensitizing environment at an elevated temperature that is below the melting point of the polyethylene, wherein the polyethylene has reduced free radical content and preferably has no residual free radicals detectable by electron spin resonance.

In accordance with another aspect of the invention the irradiation is carried out in air or inert environment selected from a group consisting of nitrogen, argon, helium, neon, and any in gas known in the art.

In accordance with still another aspect of the invention, the mechanical deformation is uniaxial, channel flow, uniaxial compression, biaxial compression, oscillatory compression, tension, uniaxial tension, biaxial tension, ultra-sonic oscillation, bending, plane stress compression (channel die) or a combination of any of the above and performed at a temperature that is below the melting point of the polyethylene in presence or absence of a sensitizing gas.

Yet in accordance with another aspect of the invention, mechanical deformation of the polyethylene is conducted at a temperature that is less than the melting point of the polyethylene and above room temperature, preferably between about 100° C. and about 137° C., more preferably between about 120° C. and about 137° C., yet more preferably between about 130° C. and about 137° C., and most preferably at about 135° C.

In one aspect, the annealing temperature of the irradiated crosslinked polyethylene below the melting point of the polyethylene, preferably less than about 145° C., more preferably less than about 140° C., and yet more preferably less than about 137° C.

Yet in another aspect, there is provided an irradiated crosslinked polyethylene, wherein elastic modulus of the polyethylene is about equal to or higher than that of the starting unirradiated polyethylene.

In accordance with the present invention, there is provided a method of making an irradiated crosslinked polyethylene comprising irradiating at a temperature that is below the melting point of the polyethylene, optionally in a sensitizing environment; mechanically deforming the polyethylene in order to reduce the concentration of residual free radical and optionally annealing below the melting point of the polyethylene, preferably at about 135° C., in order to reduce the thermal stresses.

In accordance with one aspect of the invention, there is provided a method of mechanical deformation of polyethylene, optionally in presence of a sensitizing environment, at an elevated temperature that is below the melting point of the polyethylene, preferably at about 135° C., wherein the polyethylene has reduced free radical content and preferably has no residual free radical detectable by electronic spin resonance.

In accordance with another aspect of the invention, there is provided a method of deforming polyethylene, wherein the temperature is less than the melting point of the polyethylene and above room temperature, preferably between about 100° C., and about 137° C., more preferably between about 120° C. and about 137° C., yet more preferably between about 130° C. and about 137° C., and most preferably at about 135° C.

Yet in another aspect of the present invention, there is provided a method of treating irradiated crosslinked polyethylene composition in order to reduce the residual free radials comprising steps of: mechanically deforming the polyethylene; and annealing at a temperature that is below the melting point of the polyethylene in order to reduce the thermal stresses, wherein the mechanical deformation is performed (preferably at about 135° C.), optionally in presence of a sensitizing environment.

Still in another aspect of the invention, there is provided an irritated crosslinked polyethylene composition made by the process comprising steps of: irradiating at a temperature that is below the melting point of the polyethylene; mechanically deforming the polyethylene below the melting point of the irradiated polyethylene in order to reduce the concentration of residual free radicals; annealing at a temperature above the melting point; and cooling down to room temperature.

In another aspect, the invention provides a method of making an irradiated crosslinked polyethylene composition comprising steps of: mechanically deforming the polyethylene at a solid- or a molten-state; crystallizing/solidifying the polyethylene at the deformed state; irradiating the polyethylene below the melting point of the polyethylene; and heating the irradiated polyethylene above or below the melting point in order to reduce the concentration of residual free radicals and to recover the original shape or preserve shape memory.

These and other aspects of the present invention will become apparent to the skilled person in view of the description set forth below.

### BRIEF DESCRIPTION OF THE DRAWINGS

FIG. 1 depicts C-CI-SA sample compressed at room temperature to CR 2.7 (a) before and (b) after annealing.

FIG. 2 shows ESR signals for the presence of free radicals in CC samples processed at room temperature and at 130° C.

FIG. 3 illustrates DSC thermogram for the sample compressed to CR 2.1 at 130° C. after compression, irradiation, annealing and melting.

FIG. 4 shows schematically the channel die set-up used in preparing some of the samples described in the Examples disclosed herein. The test sample A is first heated to a desired temperature along with the channel die B. The channel die B is then placed in a compression molder and the heated sample A is placed and centered in the channel. The plunger C, which is also preferably heated to the same temperature, is placed in the channel. The sample A is then compressed by pressing the plunger C to the desired compression ratio. The flow direction (FD), wall direction (WD), and compression direction (CD) are as marked.

### DETAILED DESCRIPTION OF THE INVENTION

The present invention describes methods that allow reduction in the concentration of residual free radicals in irradiated polyethylene, preferably to undetectable levels. This method involves contacting the irradiated polyethylene with a sensitizing environment, and heating the polyethylene to above a critical temperature that allows the free radicals to react with the sensitizing environment. The invention also describes processes of making crosslinked wear-resistant polyethylene having reduced free radical content, preferably containing substantially no residual free radicals, by mechanically deforming the irradiated PE either with or without contact with sensitizing environment during irradiation and annealing the post-irradiated PE at a temperature that is above the melting point of the PE.

The material resulting from the present invention is a crosslinked polyethylene that has reduced residual free radicals, and preferably no detectable free radicals, while not substantially compromising the crystallinity and modulus.

According to the invention, the polyethylene is irradiated in order to crosslink the polymer chains. In general, gamma irradiation gives a high penetration depth but takes a longer time, resulting in the possibility of some oxidation. In general, electron irradiation gives more limited penetration depths but takes a shorter time, and hence the possibility of oxidation is reduced. The irradiation dose can be varied to control the degree of crosslinking and crystallinity in the final polyethylene product. Preferably, a dose of greater than about 1 kGy is used, more preferably a dose of greater than about 20 kGy is used. When electron irradiation is used, the energy of the electrons can be varied to change the depth of penetration of the electrons, thereby controlling the degree of penetration of crosslinking in the final product. Preferably, the energy is about 0.5 MeV to about 10 MeV, more preferably about 5 MeV to about 10 MeV. Such variability is particularly useful when the irradiated object is an article of varying thickness or depth, for example, an articular cup for a medical prosthesis.

The invention also provides an improved irradiated crosslinked polyethylene, containing reduced free radical concentration and preferably containing substantially no detectable free radicals, made by the process comprising steps of contacting the irradiated polyethylene with a sensitizing environment; annealing at a temperature that is above the melting point of the polyethylene; and in presence of a sensitizing environment in order to reduce the concentration of residual free radicals, preferably to an undetectable level.

According to the invention, the wear resistance of polyethylene can be reduced by deforming the polyethylene to impart permanent deformation, irradiating the deformed polyethylene, and heating the irradiated polyethylene. The heating of the deformed polyethylene is done above the melt according to one aspect of the invention. The polyethylene of the invention has better mechanical properties than the first generation melt-irradiated polyethylene.

According to one embodiment of the invention, polyethylene is shaped into a cylinder, rectangular prism with a square base, rectangular prism with a rectangular base, or a cylinder with an elliptical base before deformation.

According to another embodiment, polyethylene is deformed using one or more of the following methods: uniaxial compression, channel-die deformation, tensile deformation, torsional deformation, and the like.

In one embodiment, polyethylene is deformed at room temperature or above the room temperature. In another embodiment, polyethylene is deformed at below its melting point or above its melting point.

In another embodiment, polyethylene is deformed with uniaxial compression or channel-die compression to a compression ratio of at least 1.1, 2, 2.5 or more than 2.5.

In another embodiment, deformed polyethylene is irradiated to a dose level of at least 10 kGy, 25 kGy, 40 kGy, 50 kGy, 65 kGy, 75 kGy, or 100 kGy, or more than 100 kGy.

In another embodiment, the deformed and irradiated polyethylene is heated to a temperature below or above the melt.

In another embodiment, the deformed, irradiated, and heated polyethylene is machined to make an article, such as a medical device.

In another embodiment, the medical device is packaged and sterilized using methods such as gas plasma, ethylene oxide, gamma irradiation, or electron-beam irradiation.

In another embodiment, the polyethylene is sequentially cycled through deformation, irradiation, and heating steps more than once to achieve a desired cumulative radiation dose level.

In another embodiment, the starting polyethylene material (for example, UHMWPE) contains an antioxidant and/or its derivatives, such as α-tocopherol or tocopherol acetate.

In another embodiment, the α-tocopherol containing polyethylene material (for example, UHMWPE) is mechanically deformed and irradiated. Subsequently the polyethylene material (for example, UHMWPE) is heated to either below or above the melting point to at least partially recover the original shape or preserve shape memory following pre-irradiation mechanical deformation.

In another embodiment, the mechanical deformation step in the embodiments presented herein is carried out at any temperature below or above the melt temperature of the polymer such as polyethylene material (for example, UHMWPE).

In another embodiment, the post-irradiation heating step used in the embodiments presented herein to at least partially and in some instances fully recover the original shape or preserve shape memory following pre-irradiation mechanical deformation is carried out at any temperature below or above the melting temperature of the polymer such as polyethylene material (for example, UHMWPE).

The present invention provides methods of treating polyethylene, wherein crystallinity of the polyethylene is higher than that of the starting unirradiated polyethylene or irradiated polyethylene that has been melted, wherein crystallinity of the polyethylene is at least about 51%, wherein elastic modulus of the polyethylene is about the same as or is higher than that of the starting unirradiated polyethylene.

The present invention describes that the deformation can be of large magnitude, for example, a compression ratio of 2 in a channel die. The deformation can provide enough plastic deformation to mobilize the residual free radicals that are trapped in the crystalline phase. It also can induce orientation in the polymer that can provide anisotropic mechanical properties, which can be useful in implant fabrication. If not desired, the polymer orientation can be removed with an additional step of annealing at an increased temperature below or above the melting point.

According to another aspect of the invention, a high strain deformation can be to imposed on the irradiated component. In this fashion, free radicals trapped in the crystalline domains likely can react with free radicals in adjacent crystalline planes as the planes pass by each other during the deformation induced flow. High frequency oscillation, such as ultrasonic frequencies, can be used to cause motion in the crystalline lattice. This deformation can be performed at elevated temperatures that is above or below the melting point of the polyethylene, and with or without the presence of a sensitizing gas. The energy introduced by the ultrasound yields crystalline plasticity without an increase in overall temperature.

The present invention also provides methods of further annealing following free radical elimination below melting point. According to the invention, elimination of free radicals below, the melt is achieved either by the sensitizing gas methods and/or the mechanical deformation methods. Further annealing of crosslinked polyethylene containing reduced or no detectable residual free radicals is done for various reasons, for example:

1. Mechanical deformation, if large in magnitude (for example, a compression ratio of two during channel die deformation), will induce molecular orientation, which may not be desirable for certain applications, for example, acetabular liners. Accordingly, for mechanical deformation:
a) Annealing below the melting point (for example, less than about 137° C.) is utilized to reduce the amount of orientation and also to reduce some of the thermal stresses that can persist following the mechanical deformation at an elevated temperature and cooling down. Following annealing, it is desirable to cool down the polyethylene at slow enough cooling rate (for example, at about 10° C./hour) so as to minimize thermal stresses. If under a given circumstance, annealing below the melting point is not sufficient to achieve reduction in orientation and/or removal of thermal stresses, one can heat the polyethylene to above its melting point.
b) Annealing above the melting point (for example, more than about 137° C.) can be utilized to eliminate the crystalline matter and allow the polymeric chains to relax to a low energy, high entropy state. This relaxation will lead to the reduction of orientation in the polymer and will substantially reduce thermal stresses. Cooling down to room temperature is then carried out at a slow enough cooling rate (for example, at about 10° C./hour) so as to minimize thermal stresses.

2. The contact before, during, and/or after irradiation with a sensitizing environment to yield a polyethylene with no substantial reduction in its crystallinity when compared to the reduction in crystallinity that otherwise occurs following irradiation and subsequent melting. The crystallinity of polyethylene contacted with a sensitizing environment and the crystallinity of radiation treated polyethylene is reduced by annealing the polymer above the melting point (for example, more than about 137° C.). Cooling down to room temperature is then carried out at a slow enough cooling rate (for example, at about 10° C./hour) so as to minimize thermal stresses.

As described herein, it is demonstrated that mechanical deformation can eliminate residual free radicals in a radiation crosslinked UHMWPE. The invention also provides that one can first deform UHMWPE to a new shape either at solid- or at molten-state, for example, by compression. According to a process of the invention, mechanical deformation of UHMWPE when conducted at a molten-state, the polymer is crystallized under load to maintain the new deformed shape. Following the deformation step, the deformed UHMWPE sample is irradiated below the melting point to crosslink, which generates residual free radicals. To eliminate these free radicals, the irradiated polymer specimen is heated to a temperature above the melting point of the deformed and irradiated polyethylene (for example, above about 137°0 C.). The above process is termed as a ‘reverse-IBMA’. The reverse-IBMA (reverse-irradiation below the melt and mechanical annealing) technology can be a suitable process in terms of bringing the technology to large-scale production of UHMWPE-based medical devices.

These and other aspects of the present invention will become apparent to the skilled person in view of the description set forth below.

A “sensitizing environment” refers to a mixture of gases and/or liquids (at room temperature) that contain sensitizing gaseous and/or liquid component(s) that can react with residual free radicals to assist in the recombination of the residual free radicals. The gases maybe acetylene, chloro-trifluoro ethylene (CTFE), ethylene, or like. The gases or the mixtures of gases thereof may contain noble gases such as nitrogen, argon, neon and like. Other gases such as, carbon dioxide or carbon monoxide may also be present in the mixture. In applications where the surface of a treated material is machined away during the device manufacture, the gas blend could also contain oxidizing gases such as oxygen. The sensitizing environment can be dienes with different number of carbons, or mixtures of liquids and/or gases thereof. An example of a sensitizing liquid component is octadiene or other dienes, which can be mixed with other sensitizing liquids and/or non-sensitizing liquids such as a hexane or a heptane. A sensitizing environment can include a sensitizing gas, such as acetylene, ethylene, or a similar gas or mixture of gases, or a sensitizing liquid, for example, a diene. The environment is heated to a temperature ranging from room temperature to a temperature above or below the melting point of the material.

“Residual free radicals” refers to free radicals that are generated when a polymer is exposed to ionizing radiation such as gamma or e-beam irradiation. While some of the free radicals recombine with each other to from crosslinks, some become trapped in crystalline domains. The trapped free radicals are also known as residual free radicals.

The phrase “substantially no detectable residual free radical” refers to no detectable free radical or no substantial residual free radical, as measured by electron spin resonance (ESR). The lowest level of free radicals detectable with state-of-the-art instruments is about 10¹⁴ spins/gram and thus the term “detectable” refers to a detection limit of 10¹⁴ spins/gram by ESR.

The terms “about” or “approximately” in the context of numerical values and ranges refers to values or ranges that approximate or are close to the recited values or ranges such that the invention can perform as intended, such as having a desired degree of crosslinking and/or a desired lack of free radicals, as is apparent to the skilled person from the teachings contained herein. This is due, at least in part to the varying properties of polymer compositions. Thus these terms encompass values beyond those resulting from systematic error.

The terms “alpha transition” refers to a transitional temperature and is normally around 90-95° C.; however, in the presence of a sensitizing environment that dissolves in polyethylene, the alpha transition may be depressed. The alpha transition is believed (An explanation of the “alpha transition temperature” can be found in Anelastic and Dielectric Effects in Polymeric Solids, pages 141-143, by N. G. McCrum, B. E. Read and G. Williams; J. Wiley and Sons, N.Y., N.Y., published 1967) to induce motion in the crystalline phase, which is hypothesized to increase the diffusion of the sensitizing environment into this phase and/or release the trapped free radicals.

The term “critical temperature” corresponds to the alpha transition of the polyethylene.

The term “below melting point” or “below, the melt” refers to a temperature below the melting point of a polyethylene, for example, UHMWPE. The term “below melting point” or “below the melt” refers to a temperature less than 145° C., which may vary depending on the melting temperature of the polyethylene, for example, 145° C., 140° C. or 135° C., which again depends on the properties of the polyethylene being treated, for example, molecular weight averages and ranges, batch variations, etc. The melting temperature is typically measured using a differential scanning calorimeter (DSC) at a heating rate of 10° C. per minute. The peak melting temperature thus measured is referred to as melting point and occurs, for example, at approximately 137° C. for some grades of UHMWPE. It may be desirable to conduct a melting study on the starting polyethylene material in order to determine the melting temperature and to decide upon an irradiation and annealing temperature.

The term “pressure” refers to an atmospheric pressure, above the ambient pressure, of at east about 1 atm for annealing in a sensitizing environment.

The term “annealing” refers to heating the polymer above or below its peak melting point. Annealing time can be at least 1 minute to several weeks long. In one aspect the annealing time is about 4 hours to about 48 hours, preferably 24 to 48 hours and more preferably about 24 hours. The annealing time required to achieve a desired level of recovery following mechanical deformation is usually longer at lower annealing temperatures. “Annealing temperature” refers to the thermal condition for annealing in accordance with the invention.

The term “contacted” includes physical proximity with or touching such that the sensitizing agent can perform its intended function. Preferably a polyethylene composition or pre-form is sufficiently contacted such that it is soaked in the sensitizing agent, which ensures that the contact is sufficient. Soaking is defined as placing the sample in a specific environment for a sufficient period of time at an appropriate temperature. The environment include a sensitizing gas, such as acetylene, ethylene, or a similar gas or mixture of gases, or a sensitizing liquid, for example, a diene. The environment is heated to a temperature ranging from room temperature to a temperature below the melting point of the material. The contact period ranges from at least about 1 minute to several weeks and the duration depending on the temperature of the environment. In one aspect the contact time period at room temperature is about 24 hours to about 48 hours and preferably about 24 hours.

The term “Mechanical deformation” refers to a deformation taking place below the melting point of the material, essentially ‘cold-working’ the material. The deformation modes include uniaxial, channel flow, uniaxial compression, biaxial compression, oscillatory compression, tension, uniaxial tension, biaxial tension, ultra-sonic oscillation, bending, plane stress compression (channel die) or a combination of any of the above. The deformation could be static or dynamic. The dynamics deformation can be a combination of the deformation modes in small or large amplitude oscillatory fashion. Ultrasonic frequencies can be used. All deformations can be performed in the presence of sensitizing gases and/or at elevated temperatures. The mechanical deformation steps also can be carried out at any temperature below or above the melt temperature of the polyethylene material.

The term “deformed state” refers to a state of the polyethylene material following a deformation process, such as a mechanical deformation, as described herein, at solid or at melt. Following the deformation process, deformed polyethylene at a solid state or at melt its be allowed to solidify/crystallize while still maintains the deformed shape or the newly acquired deformed state.

“IBMA” refers to irradiation below the melt and mechanical annealing. “IBMA” was formerly referred to as “CIMA” (Cold Irradiation and Mechanically Annealed).

Sonication or ultrasonic at a frequency range between 10 and 100 kHz is used, with amplitudes on the order of 1-50 microns. The time of sonication is dependent on the frequency and temperature of sonication. In one aspect, sonication or ultrasonic frequency ranged from about 1 second to about one week, preferably about 1 hour to about 48 hours, more preferably about 5 hours to about 24 hours and yet more preferably about 12 hours.

By ultra-high molecular weight polyethylene (UHMWPE) is meant chains of ethylene that have molecular weights in excess of about 500,000 g/mol, preferably above about 1,000,000 g/mol, and more preferably above about 2,000,000 g/mol. Often the molecular weights can reach about 8,000,000 g/mol or more. By initial average molecular weight is meant the average molecular weight of the UHMWPE starting material, prior to any irradiation. See U.S. Pat. No. 5,879,400; PCT/US99/16070, filed on Jul. 16, 1999. WO 20015337, and PCT/US97/02220, filed Feb. 11, 1997, WO 9729793, for properties of UHMWPE.

By “crystallinity” is meant the fraction of the polymer that is crystalline. The crystallinity is calculated by knowing the weight of the sample (weight in grams), the heat absorbed by the sample in melting (E, in J/g) and the heat of melting of polyethylene crystals (ΔH=291 J/g), and using the following equation:
% Crystallinity=E/w·ΔH

By tensile “elastic modulus” is meant the ratio of the nominal stress to corresponding strain form strains as determined using the standard test ASTM 638 M III and the like or their successors.

The term “conventional UHMWPE” refers to commercially available polyethylene of molecular weights greater than about 500,000. Preferably the UHMWPE starting material has an average molecular weight of greater than about 2 million.

By “initial average molecular weight” is meant the average molecular weight of the UHMWPE starting material, prior to any irradiation.

The term “interface” in this invention is defined as the niche in medical devices formed when an implant is in a configuration where the polyethylene is in functional relation with another piece (such as a metallic or a polymeric component), which forms an interface between the polymer and the metal or another polymeric material. For example, interfaces of polymer-polymer or polymer-metal in medical prosthesis such as, orthopedic joints and bone replacement parts, e.g., hip, knee, elbow or ankle replacements. Medical implants containing factory-assembled pieces that are in intimate contact with the polyethylene form interfaces. In most cases, the interfaces are not accessible to the ethylene oxide (EtO) gas or the gas plasma (GP) during a gas sterilization process.

The piece forming an interface with polymeric material can be metallic. The metal piece in functional relation with polyethylene, according to the present invention, can be made of a cobalt chronic alloy, stainless steel titanium, titanium alloy or nickel cobalt alloy, for example.

The products and processes of this invention also apply to various types of polymeric materials, for example, high-density-polyethylene, low-density-polyethylene, linear-low-density-polyethylene, UHMWPE, and polypropylene.

The invention is further demonstrated by the following example, which do not limit the invention in any manner.

### EXAMPLES

A. Materials.

Compression molded virgin GUR 1050 UHMWPE (Perplas Ltd., Lancashire, UK) was machined into cylinders (152.4×76.2 mm). The cylinders were pre-heated in a convection oven at 130° C. for 1 hour and then compressed to a compression ratio (CR) of 2.1 or 2.7. Samples were subsequently irradiated to 100 kGy (Sterigenics, Charlotte N.C.). Some samples were annealed below the melt in a convention oven (C-CI-SA) while some were annealed above the melt at 160° C. in vacuum (C-CI-SM). The samples left unprocessed after the compression step are referred to as CC samples. A virgin GUR 1050 puck irradiated to 100 kGy and subsequently melted in vacuum (CISM) was used as a control, representing first generation highly crosslinked UHMWPE.

B. Methods.

Tensile mechanical properties were determined per ASTM D-638 in two directions: the direction of uniaxial compression (CD), and the direction orthogonal to CD in the compression plane, referred to as wall direction (WD). This was to characterize the extent of anisotropy in the mechanical properties. The ultimate tensile strength (UTS), yield strength (YS), work to failure (W_{f}) and elongation-to-break (E_{b}) are reported in this study.

The crystallinity (ψ) and peak melting temperature (Tₘ) of the tested samples were determined using a Q1000 DSC (TA Instruments, Newark, Del.). The heating and cooling rate was 10° C./min. Crystallinity, was calculated by integrating the enthalpy peak from 20° C. to 160° C., and normalizing it with the enthalpy of melting four 100% crystalline polyethylene (291 J/g).

Specimens were cut from the bulk of the samples and analyzed on a Bruker EMX EPR system (Bruker BioSpin Corporation, Billerica, Mass.) at the University of Memphis for free radical concentration.

Bidirectional pin-on-disk (POD) wear test was conducted on cylindrical pins of 13 mm diameter and 9 mm height machined such that the articular surface of the pins was in the CD-WD plane.

Crosslink density was determined as described elsewhere (see Muratoglu et al., Biomaterials, 1999. 20:p. 1463-1470).

C. Results and Discussion.

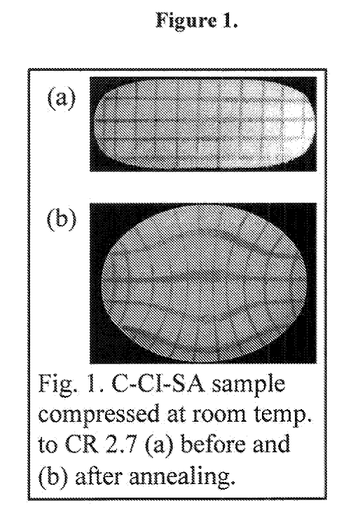

The annealing and melting of UHMWPE after compression and irradiation led to a near full recovery of the original dimensions as shown in FIG. 1.

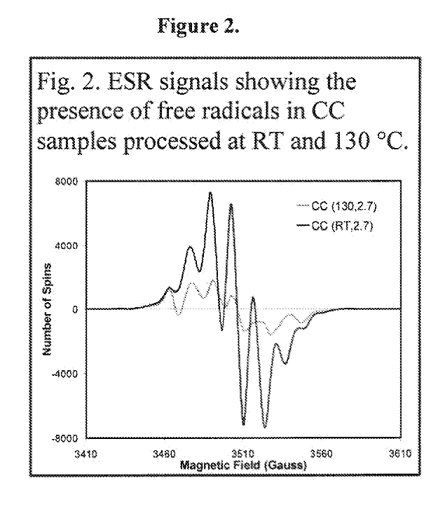

The irradiated samples showed presence of free radicals (FIG. 2). The annealing or melting of the compressed and irradiated samples decreased the free radical concentration to undetectable levels.

Deformation prior to irradiation is a potential for anisotropy in the material. Annealing of the irradiated samples resulted in anisotropy for both compression ratios; while melting led to an isotropic material for the lower compression ratio (see Table 1). Therefore, in terms of isotropy, the deformed (CR=2.1), irradiated and melted sample was equivalent to the first generation highly crosslinked UHMWPE (CISM).

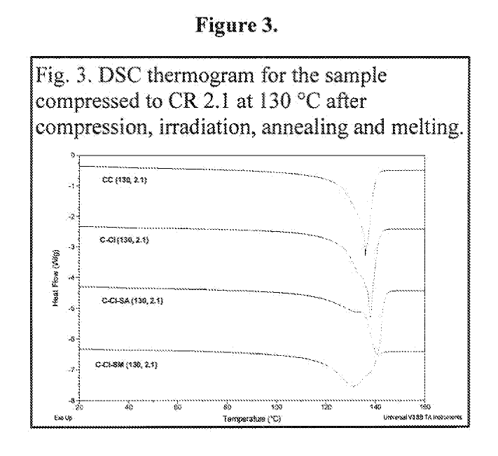

FIG. 3 shows the effect of each processing step on the thermal properties of the C-CI-SM sample compressed to 2.1 at 130° C. The crystallinity of this sample was similar to that of the CISM sample (see Table 1). The peak melting point was lower for the former.

The crosslink density values for both the C-CI-SM and control CISM samples were 165±2 mol/m3. The E_{b} values for the same compressed, irradiated and melted sample were significantly higher than that of control CISM sample (250%). Hence the C-CI-SM sample compressed at 130° C. to a CR of 2.1 represents a significantly more ductile UHMWPE in comparison with the control CISM. The work to failure (W_{f}) also showed significant improvement from 1130±35 kJ/m² for the control CISM sample to 1612±250 and 1489±229 kJ/m² for the same compressed and melted sample in the WD and CD directions respectively.

TABLE 1
Comparison of mechanical and thermal properties of CISM (control) and, C-CI-
SA and C-CI-SM samples laterally compressed to CR of 2.1 and 2.7 at 130° C.

| | C-CI-SA | | C-CI-SA | | C-CI-SM | | C-CI-SM | | |
|---|---|---|---|---|---|---|---|---|---|
| | (CR = 2.1) | | (CR = 2.7) | | (CR = 2.1) | | (CR = 2.7) | | |
| Sample | WD | CD | WD | CD | WD | CD | WD | CD | CISM |
| UTS | 45 ± 3 | 37 ± 4 | 36 ± 5 | 34 ± 4 | 42 ± 5 | 42 ± 4 | 34 ± 4 | 39 ± 5 | 39 ± 1 |
| (MPa) | | | | | | | | | |
| YS | 21 ± 0.5 | 21 ± 0.5 | 20 ± 0.5 | 19 ± 1 | 20 ± 1 | 20 ± 0.5 | 20 ± 1 | 20 ± 2 | 20 ± 0.5 |
| (MPa) | | | | | | | | | |
| E_{b} | 289 ± 7 | 343 ± 2 | 351 ± 46 | 289 ± 17 | 314 ± 34 | 315 ± 12 | 389 ± 42 | 251 ± 24 | 250 ± 9 |
| (%) | | | | | | | | | |

| | | | | | |
|---|---|---|---|---|---|
| Tₘ (° C.) | 140.6 ± 0.2 | 132.9 ± 6 | 131 ± 0.2 | 129.6 ± 0.06 | 136.3 ± 0.8 |
| χ (%) | 57 ± 0.5 | 57.5 ± 2.0 | 52.7 ± 0.7 | 59.9 ± 1.4 | 53 ± 0.5 |

Surprisingly, the compressed, irradiated and melted UHMWPE showed improved mechanical properties even though it had the same crystallinity and same crosslink density as the control CISM sample. The POD wear test resulted in a wear rate of 1.76±0.5 mg/MC for the control CISM sample. In comparison, the compressed, irradiated and melted sample wore at 1.04±0.04 mg/MC.

In conclusion, a GUR 1050 UHMWPE cylindrical bar laterally compressed to CR 2.1 at 130° C., irradiated to 100 kGy and subsequently melted showed crystallinity and wear properties comparable to that of a first-generation highly crosslinked UHMWPE, while showing superior ductility and toughness.

D. Channel Die Set-Up in Sample Preparation:

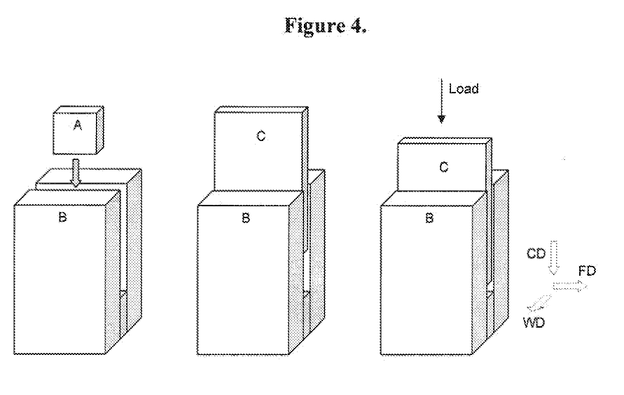

Referring to FIG. 4, a test sample ‘A’ is first heated to a desired temperature along with the channel die B. The channel die ‘B’ is then placed in a compression molder and the heated sample A is placed and centered in the channel. The plunger ‘C’, which also is preferably heated to the same temperature, is placed in the channel. The sample ‘A’ is then compressed by pressing the plunger ‘C’ to the desired compression ratio. The sample will have an elastic recovery after removal of load on the plunger. The compression ratio, □ (final height/initial height), of the test sample is measured after the channel die deformation following the elastic recovery. The flow direction (FD) wall, direction (WD), and compression direction (CD) are as marked in FIG. 4.

E. Channel Die Deformations of Irradiated Polyethylene:

Test samples of ultra-high molecular weight polyethylene are irradiated at room temperature using e-beam or gamma radiation. The samples are then placed in a channel die at 120° C., and are deformed in uniaxial compression deformation by a factor of 2. The residual free radical concentration, as measured with electron spin resonance, are compared with samples held at 120° C. for the same amount of time.

F. Channel Die Deformation of Irradiated Polyethylene Contacted with a Sensitizing Environment:

Test samples of ultra-high molecular weight polyethylene are irradiated at room temperature using e-beam or gamma radiation. The samples are contacted with a sensitizing gas, such as acetylene until saturated. The samples are then placed in a channel die at 120° C., and are deformed in uniaxial compression deformation by a factor of 2. The residual free radical concentration, as measured with electron spin resonance, are compared with samples held at 120° C. for the same amount of time.

G. Determination of Crystallinity with Differential Scanning Calorimetry (DSC) Method:

Differential scanning calorimetry (DSC) technique are used to measure the crystallinity of the polyethylene test samples. The DSC specimens are prepared from the body center of the polyethylene test sample unless it is stated otherwise.

The DSC specimen is weighed with an AND GR202 balance to a resolution of 0.01 milligrams and placed in an aluminum sample pan. The pan is crimped with an aluminum cover and placed in the TA instruments Q-1000 Differential Scanning Calorimeter. The specimen is first cooled down to 0°0 C. and held at 0° C. for five minutes to reach terminal equilibrium. The specimen is then heated to 200° C. at a heating rate of 10° C./min.

The enthalpy of melting measured in terms of Joules/gram is then calculated by integrating the DSC trace from 20° C. to 160° C. The crystallinity is determined by normalizing the enthalpy of melting by the theoretical enthalpy of melting of 100% crystalline polyethylene (291 Joules/gram). As apparent to the skilled person, other appropriate integration also can be employed in accordance with the teachings of the present invention.

The average crystallinity of three specimens obtained from near the body center of the polyethylene test sample is recorded wit a standard deviation.

The Q1000 TA Instruments DSC is calibrated daily with indium standard for temperature and enthalpy measurements.

It is to be understood that the description, specific examples and data, while indicating exemplary aspects, are given by way of illustration and are not intended to limit the present invention. Various changes and modifications within the present invention will become apparent to the skilled artisan from the discussion, disclosure and data contained herein, and thus are considered part of the invention.

1. (canceled)

2. An irradiated crosslinked polyethylene composition made by the process comprising steps of:
a) mechanically deforming a polyethylene composition;
b) crystallizing the polyethylene at the deformed state at a temperature below the melting point of polyethylene;
c) irradiating the polyethylene that is below the melting point of the polyethylene; and
d) heating the irradiated polyethylene to a temperature that is above the melting point for reduction of the concentration of residual free radicals and for shape recovery.

3. The polyethylene composition of claim 2, wherein the crystallinity of the polyethylene is about 51% or greater.

4. The polyethylene composition of claim 2, wherein the polyethylene contains substantially reduced or no detectable residual free radicals.

5. (canceled)

6. The polyethylene composition of claim 2, wherein the polyethylene is annealed below or above the melting point following crystallization.

7-9. (canceled)

10. The polyethylene composition of claim 2, wherein elastic modulus of the polyethylene is about the same as or higher than that of the stating unirradiated polyethylene.

11. The polyethylene composition of claim 2, wherein elastic modulus of the polyethylene is about the same as or higher than that of the starting irradiated polyethylene that has been melted.

12. The polyethylene composition of claim 2, wherein starting polyethylene material is in the form of a consolidated stock.

13. The polyethylene composition of claim 2, wherein starting polyethylene material is a finished product.

14. The polyethylene composition of claim 13, wherein the finished product is a medical prosthesis.

15. The polyethylene composition of claim 2, wherein the polyethylene is a polyolefin.

16. The polyethylene composition of claim 15, wherein the polyolefin is selected from a group consisting of a low-density polyethylene, high-density polyethylene, linear low-density polyethylene, ultrahigh molecular weight polyethylene (UHMWPE), a mixture thereof.

17. The polyethylene composition of claim 2, wherein the polyethylene is in intimate contact with a metal piece.

18. The polyethylene composition of claim 17, wherein the metal piece is a cobalt chrome alloy, stainless steel, titanium, titanium alloy, or nickel cobalt alloy.

19. The polyethylene composition of claim 2, wherein the polyethylene is in functional relation with another polyethylene or a metal piece, thereby forming an interface.

20. The polyethylene composition of claim 19, wherein the interface is not accessible to ethylene oxide gas or gas plasma.

21. The polyethylene composition of claim 2, wherein the mechanical deformation is uniaxial, channel flow, uniaxial compression, biaxial compression, oscillatory compression, tension, uniaxial tension, biaxial tension, ultra-sonic oscillation, bending, plane stress compression (channel die) or a combination thereof.

22. The polyethylene composition of claim 2, wherein the mechanical deformation is performed by ultra-sonic oscillation at an elevated temperature that is below the melting point of the irradiated polyethylene.

23. The polyethylene composition of claim 2, wherein the mechanical deformation is performed by ultra-sonic oscillation at an elevated temperature that is below the melting point of the polyethylene in presence of a sensitizing gas.

24. The polyethylene composition of claim 2, wherein the deforming temperature is less than about 140° C.

25. The polyethylene composition of claim 2, wherein the polyethylene is contacted with a sensitizing environment prior to irradiation.

26. The polyethylene composition of claim 25, wherein the sensitizing environment is acetylene, chloro-trifluoro ethylene (CTFE), trichlorofluoroethylene, ethylene gas, or mixtures containing noble gases thereof.

27. The polyethylene composition of claim 26, wherein the noble gas is selected from a group consisting of nitrogen, argon, helium, neon, and any inert gas known in the art.

28. The polyethylene composition of claim 27, wherein the gas is a mixture of acetylene and nitrogen.

29. The polyethylene composition of claim 28, wherein the mixture comprising about 5% by volume acetylene and about 95% by volume nitrogen.

30. The polyethylene composition of claim 25, wherein the sensitizing environment is dienes with different number of carbons, or mixtures of liquids thereof.

31. (canceled)

32. The polyethylene composition of claim 6, wherein the annealing temperature is less than about 145° C.

33. The polyethylene composition of claim 2, wherein the irradiation is carried out using gamma radiation or electron beam radiation.

34. (canceled)

35. The polyethylene composition of claim 2, wherein the polyethylene is irradiated to a dose level between about 1 and about 10,000 kGy.

36-38. (canceled)

39. The polyethylene composition of claim 2, wherein the mechanical deformation is uniaxial, channel flow, uniaxial compression, biaxial compression, oscillatory compression, tension, uniaxial tension, biaxial tension, ultra-sonic oscillation, bending, plane stress compression (channel die) or a combination thereof.

40-41. (canceled)

42. The polyethylene composition of claim 2, wherein the mechanical deformation is performed at a temperature that is less than about 135° C.

43. The polyethylene composition of claim 2, wherein the irradiation is carried out in air or inert environment.

44. The polyethylene composition of claim 6, wherein the annealing in presence of sensitizing environment is carried out at above an ambient atmospheric pressure.

45. The polyethylene composition of claim 44, wherein the annealing in the presence of sensitizing environment is carried out at above an ambient atmospheric pressure of at last about 1.0 atm.

46. The polyethylene composition of claim 44, wherein the annealing in the presence of sensitizing environment is carried with high frequency sonication.

47. The polyethylene composition of claim 2, wherein the polyethylene is irradiated to a dose level of about 10 kGy, about 25 kGy, about 40 kGy, about 50 kGy, about 65 kGy, about 75 kGy or about 100 kGy.
